(19) United States
(12) Patent Application Publication
(10) Pub. No.: US 2004/0248571 A1
(43) Pub. Date: Dec. 9, 2004

(54) Communication network location register and subscriber device

(76) Inventors: William Robinson, Grayslake, IL (US); Stephen Spear, Skokie, IL (US); Duane Rabe, Hawthorn Woods, IL (US)

Correspondence Address: MOTOROLA, INC., 1303 EAST ALGONQUIN ROAD, IL01/3RD, SCHAUMBURG, IL, 60196

(21) Appl. No.: 10/492,226

(22) PCT Filed: Sep. 23, 2002
(86) PCT No.: PCT/EP02/10684

(30) Foreign Application Priority Data
Oct. 9, 2001 (GB) 0124176.9

(51) Int. Cl. H04Q 7/20

(52) U.S. Cl. 455/433; 455/422.1

(57) ABSTRACT

The present invention relates to a subscriber device that is capable of registering on more than one communication network simultaneously, and to a location register for a communication network for recording the networks on which the subscriber device is simultaneously registered. The subscriber device may be active on all registered networks, or only on one registered network. The location register may prioritise the list of network registrations. A method of maintaining the location register and of setting up a call to the subscriber device is also disclosed.

The invention relates to a location register in a communication network and to a subscriber device. The invention also relates to a method of maintaining the location register, method of setting up a call to a subscriber using the location register, and a method for a subscriber device.

Cellular communication systems are well known. FIG. 1 is an exemplary illustration of a cellular communication system. The area covered by the cellular communication system is divided into a number of cells C1-C6 each served by a respective base station BS1-BS6 to provide communication services to a subscriber device (MS), such as a mobile telephone, within the cell. The base stations are divided into groups BS1-BS3 and BS4-BS6, and base stations in each of the two groups are connected to a respective switching center SC-A1 and SC-A2. In turn the switching centers SC-A1 land SC-A2 are connected to a further switching center SC, which in turn is connected to the rest of the communication system network, as will be understood by a skilled person. Thus the plurality of base stations are grouped together effectively splitting the total area covered by the communication network into a plurality of location areas, eg location area LA1 comprising base stations BS1-BS3 and location area LA2 comprising base stations BS4-BS6 shown in FIG. 1.

A subscriber to the communication system is able to move freely within the total area covered by the communication system network. As the subscriber moves between cells the subscriber device communicates with the base station of the current cell. This base station is called the serving base station.

When the communication system receives a call request for one of its subscribers, the communication system attempts to set up a call to the subscriber device by issuing a paging signal requesting the subscriber device to contact the network. As indicated above the subscriber is free to move throughout the total area covered by the communication system and it would create a considerable signaling traffic overhead to page the subscriber throughout the entire network. Therefore, the communication system must determine where in the network the subscriber is currently located so that the subscriber device is paged efficiently, without wasting network signaling resources.

This is achieved in existing cellular communication systems by using a location register containing information identifying the last known location area for all network subscribers.

Thus, when the communication system receives a call request for one of its subscribers, the current location of the subscriber is obtained from the location register and the subscriber can be contacted efficiently without the entire network being paged.

Clearly, in order for this technique to be effective, a signaling mechanism must be implemented to update periodically the location register information to ensure that the location information is current.

Typically, when a subscriber device is switched on in the communication system network area or enters the communication system network area the subscriber device will detect the communication system and will register on the network. The registration procedure involves an authentication of the subscriber device, typically by sending an authentication challenge to the subscriber device and authenticating a response received from the subscriber device, and the sending of location information, received by the subscriber device from the serving base station, to the location register. Thus, as shown in FIG. 1, a subscriber device MS1 switched on in cell C2 will communicate with the serving base station BS2 and after authentication of subscriber device MS1, location information A1 will be stored in the location register for subscriber device MS1.

In addition, as subscriber moves within the network area, the subscriber device MS1 will move from cell to cell. When the location area of the new serving base station is the same as the location area of the old serving base station, e.g. the subscriber has moved in direction A into cell C3, the received location information will be unchanged and no action is required. However, if the location area of the new serving base station is different from the location area of the old serving base station, e.g. the subscriber has moved in direction B into cell C5, the received location information will change from A1 to A2 and the subscriber device MS1 initiates a location update procedure in which the new location area information A2 is sent for storage in the location register.

Furthermore, the communication system network may require the subscriber device periodically to send location area information to the location register.

When the subscriber device is switched off a de-registration message is sent to the location register and the location register is updated to show that the subscriber device is no longer active in the communication system.

In the above description, a location area and a paging area are described as being congruent. However, it will be apparent to a skilled person that a location area and a paging area need not be congruent. In fact all that is required is that the communication system is able to determine which base stations to use to page a subscriber device based on the location information stored in the location register.

It is also known that in cellular communication systems such as the Global System for Mobile communications system (GSM system) and in the proposed Universal Mobile Telecommunications System (UMTS system) a subscriber device belonging to one network (the home network) is able to roam onto another network (the roaming network) and obtain communication services from the roaming network. Thus for example, a user with a subscription to a United Kingdom-based network is able to make and receive calls while traveling in, say, France.

In order for the roaming service to be provided to the subscriber, the subscriber device must be authenticated for communication services on the roaming network. In addition, once the subscriber device has been authenticated, incoming calls for the subscriber device must be routed effectively to the current location of the subscriber device.

When the subscriber device is switched on in the area covered by the roaming network (roaming network area) or otherwise enters the roaming network area the subscriber device attempts to register on the roaming network. The roaming network recognizes the subscriber device as belonging to the home network and, since only the home network holds the necessary subscriber information to authenticate the subscriber device, sends an authentication request signal to the home network. The home network responds by sending an authentication challenge and corresponding authenticated response to the roaming network. The roaming network then issues the authentication challenge to the subscriber device and if the corresponding authenticated response is received from the subscriber device, the subscriber device is considered to be authenticated.

Once the subscriber device has been authenticated, the roaming network sets up a temporary entry for the subscriber device in a location register in the roaming network. This location register is commonly called a visitor location register (VLR). The location of the subscriber device within the roaming network is recorded in the VLR as described above. In addition the roaming network informs the home network that the subscriber device has registered on the roaming network, and the home network records in its location register (commonly called the home location register (HLR)) that the subscriber device is roaming in the roaming network.

A call set up request for the subscriber device is initially routed to the home network. The HLR is checked and it is found that the subscriber device is roaming in the roaming network so the home network routes the incoming call request to the roaming network. The roaming network checks its VLR to obtain current location information for the subscriber device within the roaming network, and pages the subscriber device in the normal way. If the subscriber device responds to the page, the call can be set up.

If the subscriber device moves out of the roaming area of the first roaming network and moves into the area of a second roaming network (for example traveling from France into Germany) the subscriber device must register on the second roaming network.

Typically, the subscriber device first de-registers from the first roaming network i.e. the French network. In response to the de-registration message, the first roaming network will delete the subscriber's temporary registration from the first roaming network's VLR. In addition, the first roaming network informs the home network that the subscriber device has de-registered from the first roaming network, and the home network updates its home location register accordingly.

Once de-registered from the first roaming network, the subscriber device registers on the second roaming network i.e. the German network. The authentication process as set out above is repeated and if successful the subscriber device is registered on the second roaming network, a VLR entry for the subscriber device is created in the second network VLR and home network is informed of the successful registration on the second roaming network. The HLR entry for that subscriber is updated to show that the subscriber device is registered on the second roaming network. Subsequent call requests are routed to the second roaming network by the home network.

Alternatively, the subscriber device might not de-register from the first roaming network prior to registering on the second roaming network. In this situation, on being informed of the registration of the subscriber device on the second roaming network, the home network replaces the first roaming network by the second roaming network in the HLR and sends a de-registration message to the first roaming network. In response to the de-registration message, the first roaming network deletes the subscriber device from the first roaming network VLR.

Existing network deployments can contain a plurality of separate networks with at least partially overlapping coverage areas or closely adjacent coverage areas and it is envisaged that such network deployments will also exist in the future with the coexistence of the existing GSM systems with localized in-building systems and wide-area or islands of UMTS coverage. As a user moves within this area the user will transiently pass through these networks and the subscriber device of the user may register and de-register with the plurality of different networks. This generates an excessive overhead of location management control traffic.

It is desirable to reduce the location management control traffic signaling overhead on the air interface and signaling traffic between networks.

According to a first aspect of the present invention there is provided a location register for a communication network in which is stored information relating to a first communication network and to at least one further communication network on which a subscriber device of a subscriber to the communication network is simultaneously registered.

According to a second aspect of the present invention there is provided a method of maintaining a location register for a subscriber device of a subscriber to a home communication network, comprising the steps of: receiving and storing information relating to registration of the subscriber device in a first communication network; and receiving and storing information relating to at least one further communication network on which the subscriber device is simultaneously registered.

According to a third aspect of the present invention there is provided a method of setting up a call to a subscriber using the location register in accordance with the invention in response to a call set up request comprising the steps: determining prioritisation of networks on which the subscriber device is registered; and for prioritized networks, attempting to set up a call via the prioritized networks in priority order until call set up is successful; or for un-prioritised networks attempting a call set up on more than one network simultaneously.

According to a fourth aspect of the present invention there is provided a method for a subscriber device registered on a first network comprising the steps scanning for a second network; if a second network is detected, registering on the second network without de-registering from the first network; and storing information relating to the second network registration in addition to information relating to the first network registration.

According to a fifth aspect of the present invention there is provided a subscriber device having means arranged to store information relating to a first and at least a second network on which the subscriber device is simultaneously registered.

For a better understanding of the present invention, and to show how it may be brought into effect, reference will now be made, by way of example, to the accompanying drawings in which:

FIG. 1 is an exemplary illustration of a cellular communication system;

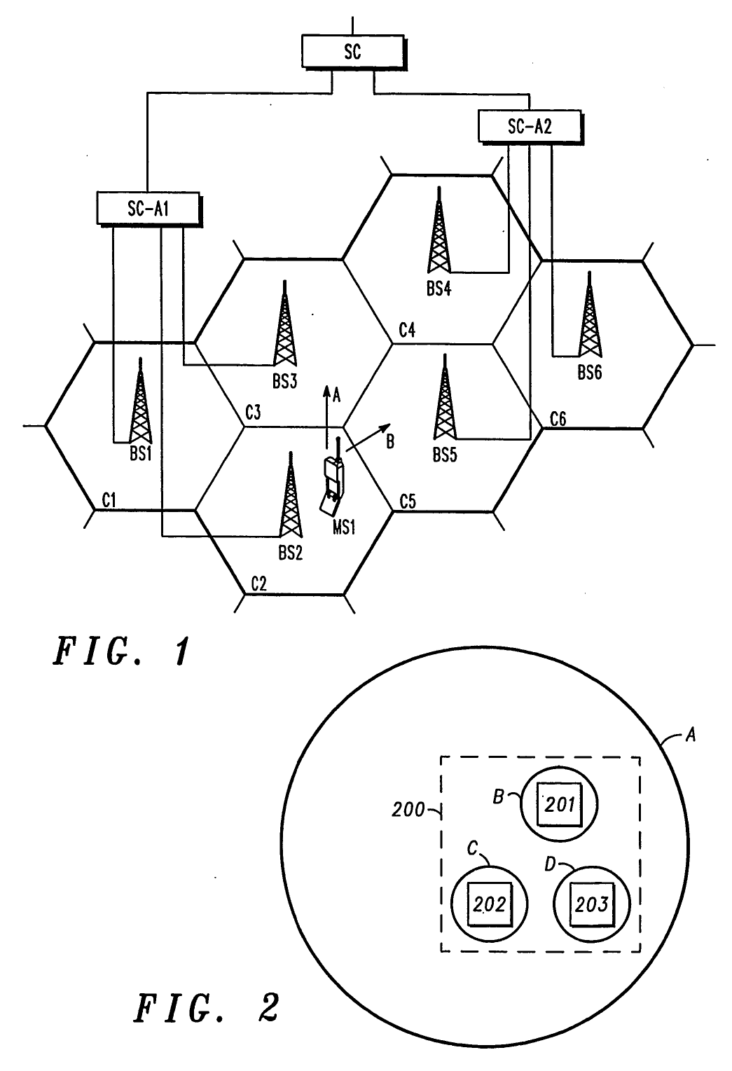

FIG. 2 shows an arrangement of networks in which the invention may be implemented;

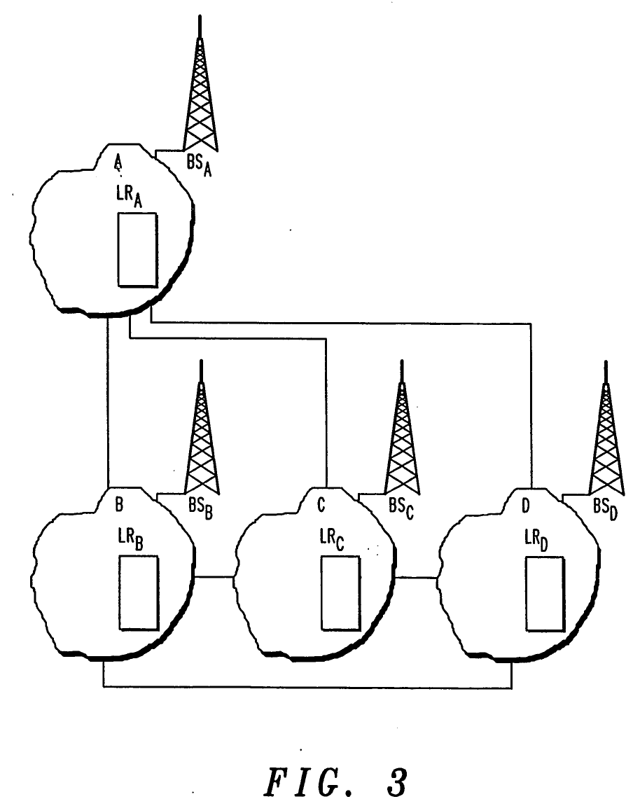

FIG. 3 shows typical connections between the networks shown in FIG. 2;

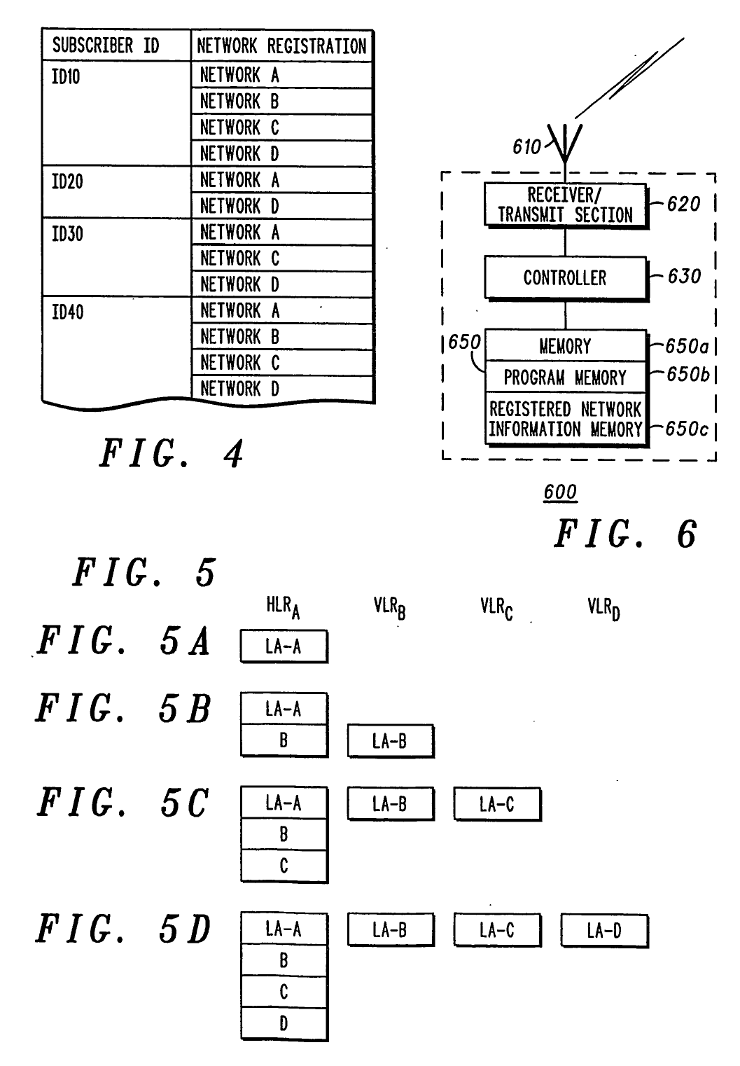

FIG. 4 shows an exemplary implementation of a location register in accordance with the invention;

FIGS. 5a-5d show exemplary entries in the location registers of the networks shown in FIGS. 2 and 3

FIG. 6 shows a schematic drawing of a subscriber device in accordance with an exemplary embodiment of the invention.

In accordance with the present invention, a subscriber device may be simultaneously registered on multiple serving networks. As a result there is a significant reduction in signaling traffic as the subscriber device moves between different networks as the subscriber device is no longer required to register and de-register each time the serving network changes.

An exemplary embodiment of the invention will now be described with reference to FIG. 2, which shows an arrangement of networks in which the invention may be implemented. FIG. 2 shows an industrial facility 200 having a plurality of buildings 201, 202, 203. The entire industrial facility is within the coverage of a wide area network A, such as a cellular network. Each of the plurality of buildings has a low power local area wireless network, network B, C and D respectively.

The networks A, B, C and D are typically connected to each other as shown in FIG. 3. Each network A, B, C and D is shown having an exemplary base station BS_{A} BS_{B} BS_{C} BS_{D}, but it will be understood by a skilled person that in general each of the networks A, B, C and D will have a plurality of base stations. Each network A, B, C and D also has a location register LR_{A} LR_{B} LR_{C} LR_{D} to enable the respective networks to keep track of subscribers to the network, to enable the network to route incoming calls to the correct location. There may be a single location register for a communication network, or the location register may be distributed within the network. In addition, as will be apparent to a skilled person, the location register may be part of a more general subscriber register holding other information about subscribers to the network, such as billing, service or preference information.

It will be understood that all location registers LR_{A} LR_{B} LR_{C} LR_{D} belonging to the networks are preferably implemented in accordance with the present invention. However, in the described industrial campus situation, it is envisaged that wide-area network A will be the home network for the majority or all of the subscribers. The location register LR_{A} of network A will now be described as an exemplary embodiment of the invention.

An exemplary implementation of the location register LR_{A} of network A is shown in FIG. 4. Four subscriber devices ID10, ID20, ID30 and ID40 are shown, although clearly details relating to many more subscriber devices would generally be included in a practical implementation of location register LR_{A} of network A.

Each of the subscriber devices ID10, ID20, ID30 and ID40 is simultaneously registered on multiple serving networks. Thus, subscriber device ID10 is simultaneously registered on networks A, B, C and D; subscriber device ID20 is simultaneously registered on networks A and D; subscriber device ID30 is simultaneously registered on networks A, C and D; and subscriber device ID10 is simultaneously registered on networks A, B, C and D.

The process for registration on a network and for updating the location register will now be described in connection with subscriber device ID10 of network A. The entries in the location registers of the networks are shown in FIGS. 5a-5d.

Initially, a subscriber having subscriber device ID10 enters the area covered by network A, or switches on subscriber device ID10 in network A, for example at the beginning of a working day. The subscriber device ID10 detects the presence of its home network A and initiates a registration procedure to register on network A. As explained above, the registration procedure typically involves an authentication of the subscriber device ID10, by sending an authentication challenge to the subscriber device ID10 and authenticating a response received from the subscriber device ID10, and the sending of location information, received by the subscriber device from the serving base station, to the home location register of network A. As shown in FIG. 5a the home location register for subscriber device ID10 records location information LA-A for the subscriber device ID10 within the home network A.

The subscriber then enters building 201 which is the building in which the subscriber usually works. The subscriber device ID10 detects the presence of local area network B and initiates a registration procedure to register on network B. In order for the subscriber device ID10 to register on network B, the subscriber device ID10 must be authenticated for communication services on network B. In addition, once the subscriber device ID10 has been authenticated, incoming calls for the subscriber device must be routed effectively to the current location of the subscriber device ID10.

Thus, when the subscriber with subscriber device ID10 enters building 201 the subscriber device ID10 attempts to register on network B. Network B recognizes the subscriber device ID10 as belonging to the network A and, since only network A holds the necessary subscriber information to authenticate the subscriber device ID10, sends an authentication request signal to the network A. Network A responds by sending an authentication challenge and corresponding authenticated response to the network B. Network B then issues the authentication challenge to the subscriber device ID10 and if the corresponding authenticated response is received from the subscriber device ID10, the subscriber device ID10 is considered to be authenticated.

Once the subscriber device has been authenticated, network B sets up a temporary entry for the subscriber device in a visitor location register (VLR) in the network B to record the location of the subscriber device within network B. In addition network B informs network A that the subscriber device ID10 has registered on the network B. Network A creates an additional record in its home location register that the subscriber device ID10 is also registered on network B in addition to the original registration on network A. The information stored in the network A HLR and the network B VLR is shown in FIG. 5b.

If the subscriber travels to building 202 for a meeting the subscriber device ID10 detects the presence of local area network C and initiates a registration procedure to register on network C in a similar manner to that described above in connection with registration on network B.

Thus, when the subscriber with subscriber device ID10 enters building 202 the subscriber device ID10 attempts to register on network C. Network C recognizes the subscriber device ID10 as belonging to the network A and obtains the necessary authentication challenge and corresponding authenticated response from the network A as explained above.

Once the subscriber device has been authenticated, network C sets up a temporary entry for the subscriber device in a visitor location register (VLR) in the network C to record the location of the subscriber device within network C. In addition network C informs network A that the subscriber device ID10 has registered on network C. Network A creates an additional record in its home location register to show that the subscriber device ID10 is also registered on network C in addition to the original registrations on networks A and B. The information stored in the network A HLR, network B VLR and network C VLR is shown in FIG. 5c.

When the meeting is over, the subscriber returns to building 201 and the subscriber device ID10 detects network B once again. However, the subscriber device is already registered on network B and so is not required to re-register on network B. No update to the location registers is therefore required (unless the registration list held in the HLR of network A is prioritized, as will be explained later).

The subscriber travels to building 203 for a further meeting and the subscriber device ID10 detects the presence of local area network D and initiates a registration procedure to register on network D in a similar manner to that described above in connection with registration on network B and C.

Thus, when the subscriber with subscriber device ID10 enters building 203 the subscriber device ID10 attempts to register on network D. Network D recognizes the subscriber device ID10 as belonging to the network A and obtains the necessary authentication challenge and corresponding authenticated response from the network A as explained above.

Once the subscriber device has been authenticated, network D sets up a temporary entry for the subscriber device in a visitor location register (VLR) in the network D to record the location of the subscriber device within network D. In addition network D informs network A that the subscriber device ID10 has registered on network D. Network A creates an additional record in its home location register to show that the subscriber device ID10 is also registered on network D in addition to the original registrations on networks A B and C. The information stored in the network A HLR, network B VLR, network C VLR and network D VLR is shown in FIG. 5d.

The subscriber now has to return to building 202 and subscriber device ID10 detects network C once again. However, the subscriber device is already registered on network C and so is not required to re-register on network C. Again, no update to the location registers is required (unless the registration list held in the HLR of network A is prioritized, as will be explained later).

FIG. 6 shows a schematic drawing of a subscriber device 600 in accordance with an exemplary embodiment of the invention. Only features relevant to the operation of the invention are shown, and a skilled person will understand that other parts of the subscriber device not relevant to an explanation of the invention have been omitted for clarity.

The subscriber device 600 has an antenna 610 coupled to a receive/transmit section 620 for enabling communication with a communication network (not shown). The transmit/receive section 620 is controlled by a controller 630 operating under the control of an operating program stored in a memory 650a to receive or transmit radio-frequency signals. Typically, control channel information signals, paging channel information signals and traffic channel signals are received, and control channel information signals and traffic channel signals are transmitted.

Memory 650b stores information needed for operation of the device in the communication network, such as information relating to control or paging channels in a GSM system. Obviously, the information needed for operation of the device will depend on the communication network type. Thus, for example, when the subscriber device is scanning for control channels in a GSM system, the controller 630 will obtain the necessary control channel information from the memory 650b and control the operation of the receive/transmit section 620 to listen to the control channel, and decode the control channel information. Again, for example, if the subscriber device is monitoring a paging channel for pages from a GSM network, the controller 630 will obtain the necessary paging channel information from the memory 650b and control the operation of the receive/transmit section 620 to listen to the paging channel, and decode the paging channel information.

Memory 650c stores registered network information in accordance with the invention generated during operation of the subscriber device 600, as will be described in more detail below.

Although memories 650a, 650b and 650c are shown as constituent parts of memory 650, a skilled person will understand that separate physical memories may be used for memories 650a, 650b and 650c or any combination of memories 650a, 650b and 650c.

The operation of the subscriber device within the communication system will now be described with reference to the registration of subscriber device ID10 on networks A B C and D described above.

In the situation when the subscriber device ID10 is initially switched on in network A the subscriber device ID10 initially scans to find a control channel and thereafter registers on network A as described above and as will be known by a skilled person. The registration of the subscriber device on network A is recorded in memory 650c.

Thereafter, the subscriber device ID10 performs a location update as the subscriber device moves between location areas within network A, or periodically if requested by network A. In addition, the subscriber device ID10 listens to the paging channel allocated by network A in order to be able to respond to paging requests.

In addition, the subscriber device periodically scans for control channels on other networks, such as the local area wireless networks B, C and D, using control channel information relating to the local area wireless networks B, C and D stored in memory 650b. When the user enters building 201 as described above, the subscriber device ID10 detects a control channel belonging to network B. Thereafter the subscriber device ID10 registers on network B as described above and as is known by a skilled person. The registration of the subscriber device on network B is recorded in memory 650c.

As indicated above, the subscriber device ID10 is now registered on both network A and network B.

Again, the subscriber device ID10 periodically scans for control channels on other networks, such as the local area wireless networks C and D using control channel information relating to the local area wireless networks C and D stored in memory 650b. When the user enters building 202 as described above, the subscriber device ID10 detects a control channel belonging to network C. Thereafter the subscriber device ID10 registers on network C as described above and as is known by a skilled person. The registration of the subscriber device on network C is recorded in memory 650c.

As indicated above, the subscriber device ID10 is now registered on networks A B and C.

Again, the subscriber device ID10 periodically scans for control channels on other networks, such as the local area wireless network D using control channel information relating to the local area wireless network D stored in memory 650b. When the user enters building 203 as described above, the subscriber device ID10 detects a control channel belonging to network D. Thereafter the subscriber device ID10 registers on network D as described above and as is known by a skilled person. The registration of the subscriber device on network D is recorded in memory 650c.

As indicated above, the subscriber device ID10 is now registered on networks A B C and D.

It should be noted that when the subscriber device is registered on more than one network, the subscriber device is not necessarily active on or actively listening to all registered networks simultaneously.

In one embodiment of the invention, the subscriber device ID10 is active simultaneously on more than one network on which the subscriber device is registered. In this situation, the registered network information stored in memory 650c indicates the status of the registered networks, e.g. which of the registered networks are active. The subscriber device ID10 listens to control channels from active networks using the corresponding operational information in memory 650b and performs a location update as necessary, or as requested, for each active network. In addition, the subscriber device listens to a paging channel for each active network and responds to a network if paged by that network.

Clearly, the subscriber device must maintain information relating to active registered networks, for example it must know which control channels to listen to for each of the active registered networks, and must maintain the status of each of the networks so that if, for example, the subscriber device de-registers with a network for any reason, an appropriate alteration is made to data stored in memory 650c.

In a second embodiment of the invention, although the subscriber device ID10 is registered on more than one network, it is active on only one which would normally be the latest on which the subscriber device has registered. As a result, the subscriber device ID10 listens to a control channel from only the active network and performs a location update as necessary, or as requested, for the active network only. In addition, the subscriber device listens to a paging channel for the active network only and responds only if paged by that network. In this mode of operation, the subscriber device must maintain information relating to the single active registered network, for example it must know which control channel to listen to for the active registered network. This is the mode of operation that existing subscriber devices will adopt in a communication system in accordance with the invention.

Preferably, however, the information about other networks on which the subscriber device is registered is stored in memory 650c, as described above with reference to the first embodiment, together with the network status as active/inactive or with an indication of the current active network. This can be achieved with a memory location pointer, or by way of an ordered list, for example. The operational information in memory 650b corresponding to the current active network is then used by the subscriber device 600.

The second embodiment of the invention is advantageous in situations where one network is preferable to another. This may be, for example, where one of the registered networks can deliver service type or quality of service or data rates that are not available from other networks e.g. a UMTS or local wireless network may be preferable to a GSM network.

It should be noted that the subscriber device is able to obtain service from any network on which it is registered while in the coverage area of that network. This is because the subscriber device will be authenticated for service on all registered networks.

If the subscriber device is active on more than one registered network, as in the first embodiment of the invention, the subscriber device and/or the subscriber can choose which of the networks should be used to make a call. This choice can be made on the basis, for example, of the quality of service and/or the data rate and/or cost of the available registered networks.

If the subscriber device is active only on one network, as in the second embodiment of the invention, the subscriber device would normally use the active network to make a call. However, it would be possible for the subscriber device to obtain service from another network on which the subscriber device is registered by first scanning for a control channel of the other registered network and then synchronizing to the other registered network.

The network registrations in the location register maintained by the home network for its subscribers (in this case network A for subscriber device ID10) may be maintained in a prioritized or semi-prioritised list, or in a non-prioritised list.

So, for example, the network the subscriber has most recently registered on may be given the highest priority in the registration list. Alternatively, the network that has most recently successfully paged the subscriber may be given the highest priority in the registration list. As a further alternative the network with the most recent location update may be given the highest priority in the registration list. The prioritization of network on which to attempt a call set up may also be made on the basis of cost of delivering the call, required data rate or service availability, expected quality of service, freshness of last confirmed location, time of day, or other such criteria. This choice may be made dynamically by the home network on receipt of a call set up request, for example, depending on the best network to deliver the requested call.

When a call request for a subscriber is received by network A, the location register of network A is consulted to determine the current location of the subscriber to enable the call to be set up. If the subscriber device is registered on only one network, the call can be set up via that network. If the subscriber device is registered on more than one network, an attempt may be made to set up the call via the highest priority network recorded in the location register. If the call set up attempt on the highest priority network fails, an attempt may be made to set up the call via the second-highest priority network, and so on until the call set-up is successful or call set up attempts on all registered networks have failed. Alternatively, a call set up attempt can be made on all registered networks simultaneously.

Thus the present invention enables improved performance in a situation in which a plurality of separate networks overlap by providing for simultaneous registration on the plurality of networks thus significantly reducing signaling overhead caused by repeated registration and de-registration.

It is particularly advantageous where the plurality of different networks offer different capabilities or technologies, for example in mixed GSM/UMTS or GSM/wireless local area systems.

While the invention has been described with reference to preferred embodiments of the invention, it will be clear to a skilled person that the invention may be implemented in other ways within the scope of the appended claims.

1. A location register for a communication network in which is stored information relating to a first communication network and to at least one further communication network on which a subscriber device of a subscriber to the communication network is simultaneously registered, the location register being arranged such that the relative priority of at least one of the communication networks can be determined.

2. The location register as claimed in claim 1 wherein the information relating to the first or the at least one further communication network relates to the location of the subscriber device within that communication network.

3. The location register as claimed in claim 1 or 2 wherein the information relating to the first or the at least one further communication network relates to the identity of the first or at least one further communication network.

4. The location register as claimed in any preceding claim having a first register entry corresponding to the first communication network and a second register entry corresponding to each of the at least one further communication network.

6. The location register as claimed in claim 1 wherein the priority accorded to a communication network depends on one or more of the following factors: the communication network on which the subscriber device has most recently registered; the communication network on which the subscriber device has most recently been paged successfully; the communication network on which the most recent location update for the subscriber device has occurred; the cost of delivering service via the communication network; required data rate for service; capability of communication network to deliver required service; quality of service available from communication network; time of day.

7. A method of maintaining a location register for a subscriber device of a subscriber to a home communication network, comprising the steps of
receiving and storing information relating to registration of the subscriber device in a first communication network; and
receiving and storing information relating to at least one further communication network on which the subscriber device is simultaneously registered wherein the information relating to the communication network is arranged such that the relative priority of at least one of the communication networks can be determined.

8. The method as claimed in claim 7 wherein the information relating to the first or at least one further communication network relates to the location of the subscriber device within that communication network.

9. The method as claimed in one of claims 7 wherein the information relating to the first or at least one further communication network relates to the identity of the first or at least one further communication network.

10. The method as claimed in one of claims 7 wherein a first location register entry corresponding to the first communication network and a further location register entry corresponding to each of the at least one further communication network is created.

12. The method as claimed in claim 7 wherein the priority accorded to a communication network depends on one or more of the following factors: the communication network on which the subscriber device has most recently registered; the communication network on which the subscriber device has most recently been paged successfully; the communication network on which the most recent location update for the subscriber device has occurred; the cost of delivering service via the communication network; required data rate for service; capability of communication network to deliver required service; quality of service available from communication network; time of day.

13. A method of setting up a call to a subscriber using the location register as claimed in one of claims 1 in response to a call set up request comprising the steps:
determining prioritisation of networks on which the subscriber device is registered; and
for prioritized networks, attempting to set up a call via the prioritized networks in priority order until call set up is successful; or
for un-prioritised networks attempting a call set up on more than one network simultaneously.

14. A method for a subscriber device registered on a first network comprising the steps
scanning for a second network;
if a second network is detected, registering on the second network without de-registering from the first network; and
storing information relating to the second network registration in addition to information relating to the first network registration wherein the information relating to the network registrations is stored such a relative priority related to the or each active communication network can be determined.

16. The method as claimed in claim 14 further comprising the step of scanning paging channels associated with an active communication network.

17. The method as claimed in one of claims 14 further comprising the step of selecting the first or the second network to make a call.

18. The method as claimed in claim 17 wherein the selection of the communication network depends on the type of call to be made.

20. A subscriber device having means arranged to store information relating to a first and at least a second network on which the subscriber device is simultaneously registered wherein the information relating to the to a first and at least a second network is stored such that a relative priority related to the first and at least a second network can be determined.

21. The subscriber device as claimed in claim 20 wherein the information relating to the network registrations is stored such that the or each active communication network can be determined.

22. The subscriber device as claimed in claim 20 further comprising means for scanning paging channels associated with an active communication network.

23. The subscriber device as claimed in one of claims 20 further comprising means for selecting the first or the second network to make a call.

24. The subscriber device as claimed in claim 23 wherein the selection of the communication network depends on the type of call to be made.
